(19) United States
(12) Patent Application Publication
(10) Pub. No.: US 2014/0320050 A1
(43) Pub. Date: Oct. 30, 2014

(54) POWER CONVERTER CIRCUIT

(71) Applicant: Siemens Aktiengesellschaft, München (DE)

(72) Inventor: Hans-Georg Köpken, Erlangen (DE)

(73) Assignee: Siemens Aktiengesellschaft, München (DE)

(21) Appl. No.: 14/366,477

(22) PCT Filed: Nov. 16, 2012
(86) PCT No.: PCT/EP2012/072841

§ 371 Date: Jun. 18, 2014

(30) Foreign Application Priority Data
Dec. 19, 2011 (EP) 11194186.0

(51) Int. Cl. H02P 6/14; H02P 6/00

(52) U.S. Cl. CPC H02P 6/14; H02P 6/002
USPC 318/400.27

(57) ABSTRACT

A power converter circuit has at least two submodules connected in a series circuit and receiving electrical power from a power source outputting a DC voltage, via an inductance. Each submodule has, on the input side, a single-phase half bridge and, on the load side, a single-phase full bridge, wherein the half bridge and the full bridge are connected on the DC voltage side in parallel with an intermediate circuit capacitor. At least one electrical line composed of several current paths connected in parallel with one another is formed in each submodule.

The invention relates to a power converter circuit as claimed in the preamble to claim 1, a circuit board and an electric motor.

A power converter circuit for supplying electrical power to the motor windings of an electric motor in a vehicle drive system is known e.g. from the publication Lukas Lamberts et al, “Modularer Hochfrequenz Umrichter für Fahrzeugantriebe” (Modular high-frequency converter for vehicle drive systems), EMA 2010, 8 to 9 Sep. 2010, Aschaffenburg.

This is a circuit which is designed to convert a DC voltage from an electrical power source into a plurality of AC voltages. The individual AC voltages are generated by series-connected submodules across which a portion of the DC voltage is dropped on the input side. In the submodules, a single-phase full bridge operating as an inverter is used to convert the corresponding portion of the DC voltage into a AC voltage which can be fed out to one of the motor windings. The single-phase full bridge comprises two single-phase half bridges which are each designed to generate an AC voltage phase, so that the two AC voltage phases are added to produce one single-phase AC voltage.

Prior to inversion by the full bridge, the partial voltages dropped across the inputs of the individual submodules are boosted by a step-up converter. The step-up converter comprises an inductor, which is connected in series between the electrical power source and the series connection of the full bridges, and an input half bridge in each submodule. The full bridge and the half bridge are connected on the DC voltage side in the submodules.

Connected in parallel with the full bridge and the input half bridge in each submodule is a DC-link capacitor which can buffer electrical energy, e.g. from a reactive power flow from the motor windings.

The object of the invention is to improve the known power converter circuit.

This object is achieved by the features of the independent claims. Preferred developments are set forth in the dependent claims.

The invention proposes that a line for feeding electrical power be subdivided into a plurality of parallel-connected current paths in each submodule of the power converter circuit of the type mentioned in the introduction.

The invention assumes that, in a submodule of the power converter circuit of the type mentioned in the introduction, the individual components are connected by a line having a single current path. However, capacity-limiting points, so-called bottlenecks, can occur on this single current path which not only determine the maximum transmittable power, but there is generally the greatest risk of other electrical components being adversely affected by said bottlenecks in the event of a fault.

Thus, for example, current concentrations can occur at a contacting point between the submodule and a connected electrical load, as the electrical line resistance between the submodule and the electrical load varies at said contacting point. These current concentrations may adversely affect the functionality of the submodule and, in extreme cases, result in failure of the entire circuit arrangement.

In contrast, the invention proposes to deliver the electrical power not on a single current path, but distributed over a plurality of parallel-connected current paths. In this way the currents are not only distributed onto the individual current paths at the capacity-limiting points, thereby ultimately enabling high current concentrations to be avoided, but adverse effects of a defective capacity-limiting point in a current path do not necessarily adversely affect the remaining current paths in the submodule.

The invention therefore specifies a power converter circuit comprising at least two submodules in a series connection which draws electrical power from a DC voltage source via an inductor. Each of said submodules has a single-phase half bridge on the input side and a single-phase full bridge on the load side, and the half bridge and the full bridge are connected on the DC voltage side and a DC-link capacitor is connected in parallel therewith. According to the invention, at least one electrical line comprising a plurality of parallel-connected current paths is formed in each submodule.

By using a plurality of current paths on a line in each submodule, the risk of failure in the event of a fault can be reduced, as the risk of a fault on a current path having an adverse effect on the corresponding submodule is lower than if a single current path were used. While this not only increases the service life of the submodules, the failure risk of the submodules and therefore of the power converter circuit is also reduced.

In a particular development of the invention, the full bridge is comprised of a number of individual full bridges corresponding to the current paths, and each current path is routed through one of the individual full bridges. In other words, in the submodules of the specified power converter circuit there is provided, for each current path, an extra full bridge circuit which feeds the electrical power from an input of the full bridge to an output of the full bridge. This development is based on the consideration that the switches of a full bridge are generally implemented as semiconductor switches. These have a particular saturation current, with the result that the power that can be carried by the full bridge is limited. The saturation current of the entire semiconductor switch arrangement could be increased by connecting a plurality of semiconductor switches in parallel. However, a fault in one of the switches of this parallel connection affects the flow of current through the rest of the switches of this parallel connection which, in the event of a fault, could cause the rest of the switches to be operated under conditions capable of damaging or even destroying them. However, the risk of such an adverse effect is reduced by providing a separate full bridge for each current path and therefore a separate current path for each switch.

In a preferred development of the invention, a current path of the electrical load is contactable at an output of each individual full bridge. In other words, the individual current paths, e.g. in the form of wires, coming from the load are not brought together for making contact at a single contact point but are connected individually to the current paths of the respective submodule at the output of the full bridge. if the submodule is implemented on a circuit board, this can be accomplished, for example, by passing the wires through the circuit board and soldering them thereto.

In a particular development of the invention, the DC-link capacitor is comprised of a number of individual DC-link capacitors corresponding to the current paths, and each individual DC-link capacitor makes contact with one of the current paths. In order to buffer reactive power surges toward the power source, the DC-link capacitor section must provide a certain capacitance, as the submodules cannot deliver electrical power to the electrical power source if the electrical power output to an electrical load is power-regulated. The higher the capacitance, the greater the technical complexity and expense. By using the individual capacitors, which are connected in parallel by the specified development, the above mentioned capacitance required for buffering the reactive power surges directed toward the power source can likewise be derived from a plurality of smaller and therefore technically simply and inexpensively implementable capacitances.

In a particular development of the invention, the half bridge is made up of a number of individual half bridges corresponding to the current paths. Each of said single half bridges is connected to one of the current paths.

In a preferred development, each individual half bridge is connected on the input side to an individual inductor. This individual inductor implements together with each half bridge section a step-up converter which enables a voltage delivered by the power source to be increased and thus provide the individual submodules, like the above mentioned full bridges, with a higher input voltage.

In another development, the specified power converter circuit comprises, in each submodule, an equipotential bonding point on which the individual current paths are electrically interconnected. In this way, for all the individual elements (individual full bridge, individual DC-link capacitor, individual half bridge) of the submodule, a common reference potential is defined which in particular allows technically simple implementation of the control and sensor systems of the submodule and therefore of the resulting converter.

The invention also specifies a circuit board comprising a circuit having a specified submodule. All the submodules with their individual elements can be mounted together on the circuit board as a circuit. Thus, the parallel connections resulting from the current paths involve comparatively little wiring complexity.

Alternatively, a plurality of circuit boards can be provided on which individual or a plurality of submodules are mounted as a circuit. Said circuit boards are wired up to create a common submodule.

The invention also specifies an electric motor which comprises a rotor-driving motor winding and a specified circuit board. With particular preference, this circuit board can be incorporated into the electric motor so that a converter having a specified submodule and the electric motor can be factory-assembled, thereby considerably simplifying final assembly.

In a development of the invention, the motor winding is made up of a number of individual windings corresponding to the current paths, each individual winding being electrically connected to one of the current paths. In other words, the development constitutes a logical step and introduces a new consistent concept wherein a large number of current paths operating adjacently to one another implement a complete circuit in each case which are connected to a power source to drive a motor.

The invention also specifies a vehicle which comprises a specified electric motor for the propulsion thereof.

The above described characteristics, features and advantages of this invention and the manner in which they can be achieved will become clearer and more readily understandable in conjunction with the following description of the exemplary embodiment which will be explained in greater detail with reference to the accompanying drawings in which:

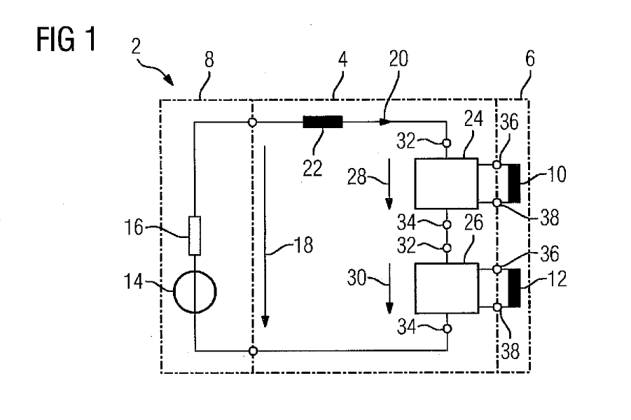

FIG. 1 shows a circuit with an example of a converter and

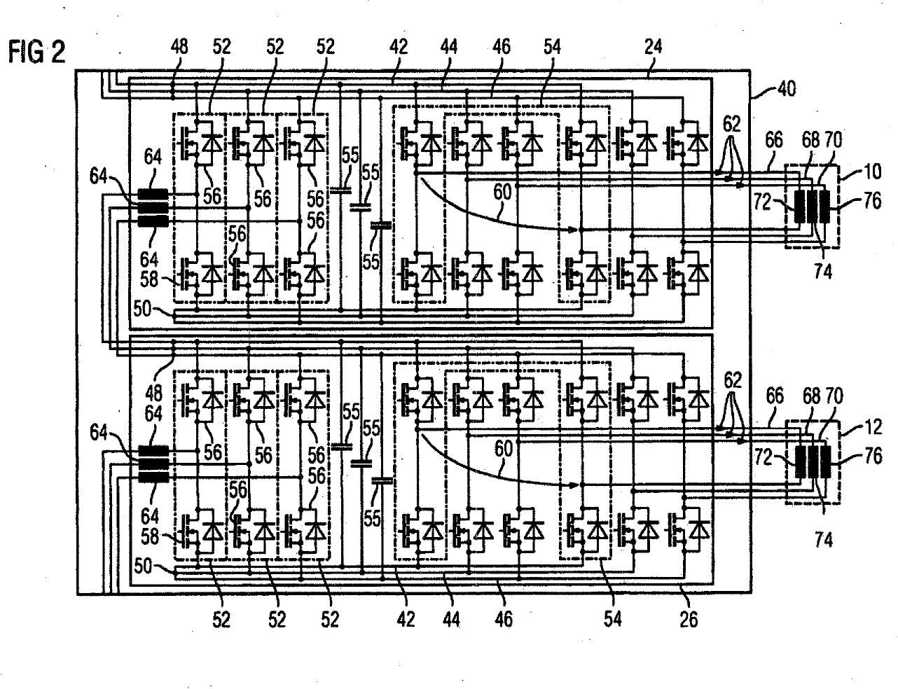

FIG. 2 shows a submodule of the converter from FIG. 1.

Reference is made to FIG. 1 which shows a circuit 2 having an example of a power converter circuit 4. The power converter circuit 4 supplies a current consuming apparatus 6 with electrical power from an electrical power source 8.

In this embodiment, the current-consuming apparatus 6 is a motor and has a first load 10 in the form of a first motor winding section and a second load 12 in the form of a second motor winding section.

In this embodiment, the electrical power source 8 is a battery 8 which can be analyzed into a voltage source 14 having an internal resistance 16 connected in series therewith. The battery 8 applies a battery voltage 18 to the power converter circuit 4 and supplies a battery current 20 to the power converter circuit 4.

Connected to the electrical power source 8 at the input side on the power converter circuit 4 is a series circuit comprising an inductor 22, which can be a coil, for example, a first submodule 24 and a second submodule 26. A first partial voltage 28 and a second partial voltage 30 is accordingly dropped across the submodules 24, 26. In addition, the first and second load 10, 12 are accordingly connected to the first and second submodule 24, 26. In this way, on the basis of the partial voltages 28, 30, the submodules 24, 26 supply the loads 10, 12 with electrical energy in a manner yet to be described. In this embodiment, two has been selected as the number of submodules 24, 26 and loads 10, 12. However, the power converter circuit 4 can possess any number of submodules 24, 26 and therefore supply any number of loads 10, 12. However, the more submodules 24, 26 connected in the series circuit, the smaller the corresponding partial voltage 28, 30.

Each submodule 24, 26 has a first input terminal 32, a second input terminal 34, a first output terminal 36 and a second output terminal 38. While the partial voltages 28 to 30 are each dropped across the first and second input terminals 34, 36, the loads 10, 12 are connected to the first and second output terminals 38, 38.

Reference is made to FIG. 2 which shows an exemplary arrangement of the submodules 24, 26 in the power converter circuit 4 of FIG. 1 on a circuit board 40.

Each submodule 24, 26 comprises a first current path 42, a second current path 44 and a third current path 46. Each of these current paths 42 to 46 implements a separate and independent sub-circuit of the power converter circuit 4, said sub-circuits being interconnected in each submodule 24, 26 at a first equipotential bonding point 48 and at a second equipotential bonding point 50. In other words, the individual sub-circuits are interconnected in parallel.

The composition of the first submodule 24 will now be described representatively for all the submodules 24, 26. For this purpose, the composition of the first current path 42 is explained representatively for all the current paths 42 to 46.

The first submodule 24 has a first half bridge 52, a full bridge 54 and a DC-link capacitor 55 which are interconnected in parallel. In FIG. 2, for the sake of clarity, only the full bridge 54 of the first current path 42 is delineated with a dashed line and provided with a reference character. Although the full bridges 54 of the remaining current paths 44, 46 are marked in FIG. 2, indicating them by a reference character would make FIG. 2 unnecessarily difficult to read.

The first half bridge 52 has a first switch 56 and a therewith in series connected second switch 58. In this embodiment the switches 56, 58 each consist of a MOSFET (metal oxide field effect transistor) not referenced more precisely and a freewheel diode connected in parallel therewith.

The first partial voltage 28 is applied to the first switch 56 while the second switch 58 is connected in series between the first switch 56 and the full bridge 54. Therefore, the first switch 56, as seen by the full bridge 54, can short-circuit the input from the battery 8, while the second switch 58 (with the first switch 56 opened) can place the full bridge 54 in the current path of the battery 8. If in each submodule 24, 26 the switches 56, 58 are opened and closed alternately in the same way, there is created together with the inductor 22 a step-up converter which sets the sum of the partial voltages 28, 30 higher than the battery voltage 18. In addition, the first submodule 24 can also be permanently removed from the series connection of the two submodules 24, 26 by the first half bridge 52 if the first switch 56 remains permanently closed.

The full bridge 54 is designed as a four-quadrant H-bridge which has a first and second half bridge not referenced more precisely. Both half bridges are essentially of similar composition to the first half bridge 52. The first partial voltage 28, which is stabilized via the DC-link capacitor 55, can be converted into an AC voltage 60 by suitably controlling the full bridge 54. For the sake of clarity, the AC voltage 60 is again only indicated for the first current path 42 in FIG. 2. The AC voltage 60 is applied to the first load 10 and causes a corresponding alternating current 62 to flow through the first load 10. If the first load 10 supplies electrical energy to the full bridge 50 implemented as a four-quadrant H-bridge, the latter can return the power flow to the first submodule 24. The control of the full bridge 54 is well known to the average person skilled in the art and will not be explained in greater detail below.

In this embodiment, the first load 10 has a number of current paths 66, 68, 70 corresponding to the number of current paths 42 to 46 of the first submodule 24. The same applies to the second load 12. Each current path 66, 68, 70 of the first load 10 is accordingly electrically connected to a current path 42 to 46 of the submodule 24. In the same way, the current paths 42 to 46 of the submodules 24, 26 are accordingly electrically interconnected one to another. Individual motor windings 72 to 76 are each connected in the current paths 66 to 70 of the first load 10 which, as already mentioned, is implemented as a motor winding section.

In this embodiment, each submodule 24, 26 in each current path 42 to 46 comprises an individual inductor 64. These individual inductors 64 can replace the inductor 22 or functionally supplement the inductor 22.

Although the invention has been illustrated and described in detail by the preferred exemplary embodiments, the invention is not limited by these examples. Other variations can be inferred therefrom by persons skilled in the art without departing from the scope of protection sought for the invention.

1.-11. (canceled)

12. A power converter circuit, comprising:
at least two submodules connected in series and receiving electrical power, via an inductor, from a power source supplying a DC voltage, each of the at least two submodules comprising, on an input side, a single-phase half bridge and, on a load side, a single-phase full bridge, and a plurality of current paths connected in parallel with one another, and
a DC-link capacitor connected in parallel with the half bridge and with the full bridge,
wherein each of the half bridges comprises a plurality of individual half bridges, with a number of the individual half bridges corresponding to a number of the current paths, and each of the full bridges comprises a plurality of individual full bridges, with a number of the individual full bridges corresponding to the number of the current paths,
wherein an input side of each of the individual half bridges is connected to one of the current paths, and
wherein each current path passes through one of the individual full bridges.

13. The power converter circuit of claim 12, wherein an output of each individual full bridge is electrically connected to a load current path of the electrical load in one-to-one correspondence.

14. The power converter circuit of claim 12, wherein the DC-link capacitor is composed of a number of individual DC-link capacitors corresponding to the number of current paths, and each individual DC-link capacitor is electrically connected to one of the current paths in one-to-one correspondence.

15. The power converter circuit of claim 12, wherein the input side of each of the individual half bridges is electrically connected to an individual inductor.

16. The power converter circuit of claim 12, wherein all of the plurality of current paths are electrically interconnected at an equipotential bonding point.

17. A circuit board with a power converter circuit, the power converter circuit comprising
at least two submodules connected in series and receiving electrical power, via an inductor, from a power source supplying a DC voltage, each of the at least two submodules comprising, on an input side, a single-phase half bridge and, on a load side, a single-phase full bridge, and a plurality of current paths connected in parallel with one another, and
a DC-link capacitor connected in parallel with the half bridge and with the full bridge,
wherein each of the half bridges comprises a plurality of individual half bridges, with a number of the individual half bridges corresponding to a number of the current paths, and each of the full bridges comprises a plurality of individual full bridges, with a number of the individual full bridges corresponding to the number of the current paths,
wherein an input side of each of the individual half bridges is connected to one of the current paths, and
wherein each current path passes through one of the individual full bridges.

18. An electric motor comprising
motor windings for driving a rotor, and
a circuit board for supplying electrical energy to the motor windings,
wherein the circuit board comprises a power converter circuit comprising
at least two submodules connected in series and receiving electrical power, via an inductor, from a power source supplying a DC voltage, each of the at least two submodules comprising, on an input side, a single-phase half bridge and, on a load side, a single-phase full bridge, and a plurality of current paths connected in parallel with one another, and
a DC-link capacitor connected in parallel with the half bridge and with the full bridge,
wherein each of the half bridges comprises a plurality of individual half bridges, with a number of the individual half bridges corresponding to a number of the current paths, and each of the full bridges comprises a plurality of individual full bridges, with a number of the individual full bridges corresponding to the number of the current paths,
wherein an input side of each of the individual half bridges is connected to one of the current paths, and
wherein each current path passes through one of the individual full bridges.

19. The electric motor of claim 18, wherein the motor winding is composed of a plurality of individual motor windings, with a number of the individual motor windings corresponding to the number of current paths, and with each individual motor winding being electrically connected to one of the current paths in one-to-one correspondence.

20. A vehicle with an electric motor for propulsion of the vehicle, the electric motor comprising
motor windings for driving a rotor, and
a circuit board for supplying electrical energy to the motor windings,
wherein the circuit board comprises a power converter circuit comprising
at least two submodules connected in series and receiving electrical power, via an inductor, from a power source supplying a DC voltage, each of the at least two submodules comprising, on an input side, a single-phase half bridge and, on a load side, a single-phase full bridge, and a plurality of current paths connected in parallel with one another, and
a DC-link capacitor connected in parallel with the half bridge and with the full bridge,
wherein each of the half bridges comprises a plurality of individual half bridges, with a number of the individual half bridges corresponding to a number of the current paths, and each of the full bridges comprises a plurality of individual full bridges, with a number of the individual full bridges corresponding to the number of the current paths,
wherein an input side of each of the individual half bridges is connected to one of the current paths, and
wherein each current path passes through one of the individual full bridges.
